(19) United States
(12) Patent Application Publication
(10) Pub. No.: US 2004/0049396 A1
(43) Pub. Date: Mar. 11, 2004

(54) Method and system for recovery of lost property

(76) Inventor: David Hope, Laguna Beach, CA (US)

Correspondence Address: Levin and Hawes, LLP., Suite 13, 384 Forest Ave., Laguna Beach, CA, 92652, US

(21) Appl. No.: 10/236,711

(22) Filed: Sep. 6, 2002

(51) Int. Cl. G06F 17/60

(52) U.S. Cl. 705/1

(57) ABSTRACT

A system and method is disclosed for the return of lost personal property. The system consists of identifying personal property with unique identification indicia. Placing the unique identification indicia on a tag with instructions on where to return the property of found, that a reward will be paid for its return and attaching that tag to the item of personal property. The information regarding the personal property, its owner and the unique identification indicia is maintained in a central registry database. Upon the finding of the lost property a finder would contact the database, make arrangements for return of the property and receive the reward upon the successful return of the lost property. The system in a preferred embodiment would operate through an Internet website and be designed to function over a very large geographical area such as the United States.

### FIELD OF THE INVENTION

The present invention relates to a system and method for identifying and recovering lost personal property and more particularly it relates to a method and system that can be used over a wide area geographical area for a substantial variety of personal property.

### BACKGROUND OF THE INVENTION

Each year millions of people lose millions of personal and business items they wish they could have returned to them. Although someone usually finds many of these lost items, they are often not returned to their original owners for a variety of reasons. Such reasons include: the fact that the items themselves are often not marked with information that clearly identifies the owner or how the item can be returned to the owner; that there is usually no clearly identifiable incentive for any finder to return the items; and that there is no easy mechanism by which such a finder can return the item to its original owner and redeem an incentive. Most people would wish to have any item that they own returned to them in the event of a loss. One obvious reason for this is that they do not want to go to the expense of having to replace the lost item. And even if they have sufficient insurance to cover the physical cost of goods, (which is not always the case), there is still the significant time, effort and inconvenience involved in having to find and shop for a replacement item, contact the insurance company and complete the insurance claims process, and hope to receive fair value from the insurers. In addition, many business and personal items have significant hidden value to their owners well in excess of the item's physical replacement value. For example, a laptop computer or personal organizer filled with data that the owner forgot to “back-up” has a value to that owner well in excess of its simple replacement value. Similarly, a pet, such as the family dog; a favorite bicycle; a briefcase full of business; a set of keys to one's home, business, or safe; each are of much more value to the original owner than their simple replacement cost.

There are some existing systems that provide a means for return of lost items. One such system used in England provides for the return of lost keys. The owner of the keys buys a policy from the key registry system and is given a tag with a number on it that can be attached to the keys of the policyholder. When the keys are lost a person finding them returns them to a local police station. The police then inform the key registry system that they have a set of lost keys, the key registry matches them with the number in their system of a policyholder of the key registry according to the matched number. The key registry then either picks up the keys and returns them to the owner, instructs the police to whom to return the keys, or informs the policyholder where to reclaim their keys, and also pays the person who found the keys a small reward.

A number of other systems have been proposed for the return of lost property under certain circumstances. One such system provides for the placing of a tag on an item of personal property, which asks anyone finding the item to take it a specific package delivery system. If the personal property is lost and then turned into the package delivery system the package delivery system can electronically read identifying information on the tag and thereby identify the owner and send it back to the owner. The owner then pays the fee set for its return. Another system provides a two-part tag that an owner of personal property can purchase from a central registry. The owner puts one of the tags on the item of personal property and retains the other in a safe place for future reference. The portion of the tag on the personal property asks anyone finding it to call the central registry and leave a telephone message with the tag number who they are and how the owner can recover the lost item form the finder. To message left by the finder of the lost article is identified by the number on the tag, the finder having been instructed to enter that number at sometime during the call. The owner of the lost item calls the central registry inputs the identifying tag number and can pick up the call left by the finder of the lost item and from the information left make contact with the finder for return of the item.

A number of other systems exist that provide for the return of lost personal property. However, all of these systems including those described above suffer from a number of deficiencies that make them uneconomical and not suited for today's world. While some may provide for anonymity and all provide for a way of identifying the lost item none are adaptable to a cover a large area such as the entire United States or other large geographical areas. A person traveling on a long trip may take off in a plane from one airport and pass through several airports before reaching their final destination. If they lose an item on the trip they might not be able to place the exact spot he or she lost it. Thus, if one loses a personal computer in the main airport in Atlanta while traveling from Philadelphia to Denver he or she will generally never see it again or when they do receive it, it will be after a long delay and the computer typically will be damaged, etc. Even if the item is identified there might not be any incentive, or any easy way for the finder to determine the value of the incentive, or easy means of returning it to the owner. Also there is no way for the owner to increase the incentive in real time in order to increase the chance of a finder returning the item, and for the finder to quickly determine the increased incentive. All of the existing systems lack the ability to provide a quick and easy means of the owner and person finding the item to quickly make contact and easily return the item while providing the person that finds the lost item with some type of assurance that they will receive something for their effort. Additionally, none really provide a general-purpose asset registry that can handle a large variety of types of personal property.

Thus, what is needed is a system and method that can provide for the safe and expeditious return of lost personal property. A system that allows the owner of the personal property to remain anonymous to the finder of the lost item but still provide an incentive to return the lost item in the form of a reward payed to the finder of the lost item. Such a system should also provide for some means of assuring the return of the lost item in a relatively undamaged state. Additionally, such a system must be flexible and allow for user interaction and be capable of functioning effectively over an extremely large geographic area.

### SUMMARY

It is an objective of the present invention to provide a method and system for the safe and expeditious return of lost personal property. It is a further objective of the present invention to provide a system that maintains the anonymity of the owner of the lost personal property and also prompts the finder of lost property to return the lost property by offering a reward. It is yet another objective to provide a system and method for the return of lost property in relatively undamaged state. It is yet a further objective to provide a flexible system and method that allows for user interaction and capable of functioning over an extremely large geographic area.

The invention accomplishes these and other objectives by providing a system for identifying items of personal property and providing for their safe and expeditious return to the owner of the personal property, the system having: 1) a central asset registry having a database of items of personal property of various individuals each of said items of personal property is identified by a unique identifying indicia, said unique identifying indicia of each item of personal property being linked to a specific owner; 2) a tag attached to each item of personal property registered with said asset registry, said tag having said unique identifying indicia emblazoned thereon that corresponds to said unique identifying indicia associated with said item of personal property in said database of said asset registry, said tag also having contact information for said asset registry and a promise of a reward to an individual who notifies said asset registry and turns in the lost item to said asset registry; 3) said asset registry and said associated database being generally accessible over a public communication network; 4) wherein upon losing a registered item of personal property, an owner of said lost item of registered personal property can notify said asset registry system to list on said database in a searchable format said item of registered personal property searchable by one or more of the is following indicia: owner, unique identifying indicia, description of the property lost and location the item was lost; and 5) wherein said owner has an option of modifying within certain preset parameters a reward to be offered for return of the lost registered item of personal property and the condition in which the lost item must be returned in order to receive all or part of said reward.

In another aspect of the present invention it provides a method for assuring the return of lost items of personal property, said method comprising the steps of: a) providing for the listing of items of personal property on a searchable database; b) assigning a unique identification indicia to each of said items of personal property, which unique identification indicia can be used to quickly identify said personal property to which said unique identifying indicia is assigned; c) attaching in a secure but detachable fashion a tag to said item of personal property, said tag having said unique identification indicia thereon as well as information on how to contact a central registry if one finds said item of personal property with said tag attached and offering an reward to anyone who finds and returns said item of personal property to said central registry; d) having an owner of said personal property contact said central registry and list said item of personal property as lost in the event that said item of personal property is lost; e) posting at an internet website of said central asset registry the fact said item of personal property has been lost; f) receiving a communication from a finder claiming to have found said lost item of personal property; g) verifying with said database that said item of personal property found by said finder is that listed on said database by confirming a match between said unique identification indicia on said tag and said unique identification indicia of said item of personal property listed in said database; h) making arrangements with said finder of said item of personal property to said asset registry; i) receiving by said central registry said item of personal property found; j) returning said item of personal property to said owner; and k) paying a preset reward to said finder.

In a further aspect of the method of present invention it includes the steps of a) after receiving return of said item of personal property inspecting said item of personal property for damages; b) having the central registry determine if any damage has occurred to the item of returned personal property; c) determining if the owner of said personal property will accept return of said personal property with any damage discovered; d) returning said personal property to said finder if it is determined said owner will not accept said personal property in its inspected state and not paying said reward or sending said personal property to said owner and paying said reward to said finder if said personal property will be accepted by said owner in its inspected state and sending the reward to said finder.

In yet a further aspect of the method of the present invention it provides the additional steps of a) having said owner of said property listed with said central registry pay a periodic subscription fee for registering said property with said central registry; see later AOL points; and b) having said owner of said property listed with said central registry pay a return fee upon the return through said registry of said personal property if it has been lost. In another alternative of the apparatus or method of this invention, it may be used by a large Internet service provider, or by a corporation such as an insurance company or similar organization, as one of various services afforded by that service provider. The invention could be offered either as a free of charge service, as a service for an additional charge, or as part of a bundle of different services being offered for a fee.

### BRIEF DESCRIPTION OF THE DRAWINGS

The invention will be better understood by an examination of the following description, together with the accompanying drawings, in which:

FIG. 1 is a schematic block type diagram of the major functional components of the present invention;

FIG. 2 is a block diagram of a basic database structure of a preferred embodiment of the present invention;

FIG. 3 is a view of what a home web page of the present invention might look like;

FIG. 4 is a schematic block type diagram of various internet communication alternatives a preferred embodiment of the present invention might have;

FIG. 5 provides various forms of the unique identifying indicia the present invention might use;

FIG. 6 is a view of two versions of the tags the present invention would use; and

FIG. 7 is a flow chart of one mode of operation of a preferred embodiment of the present invention.

### DETAILED DESCRIPTION OF THE PREFERRED EMBODIMENT

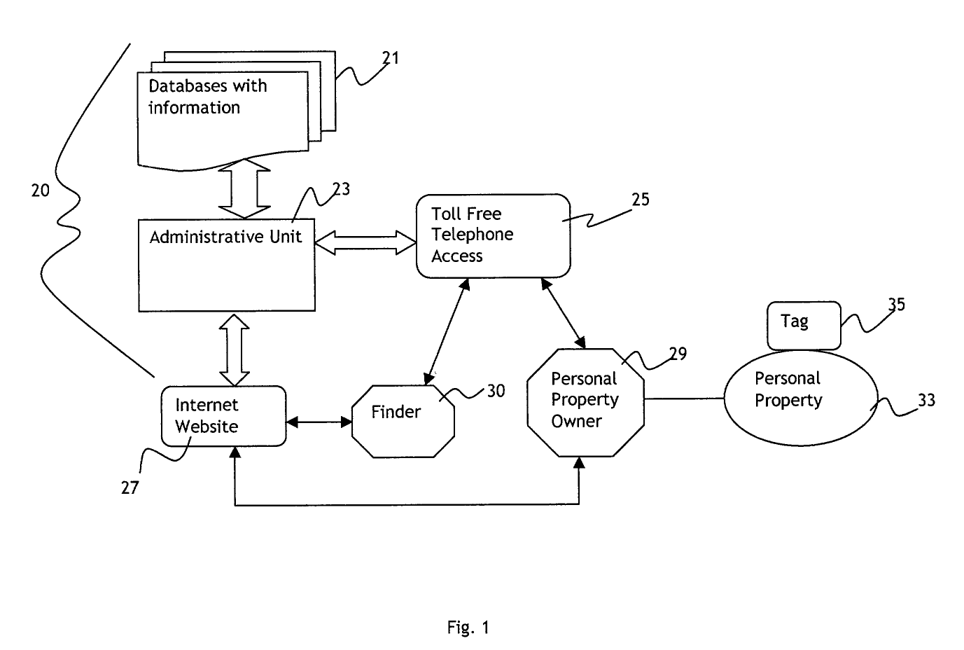

As noted above the Asset Registry and Recovery system 20 of the present invention provides a system for the recovery of lost property. It provides a unique method of identifying various pieces of personal property and providing a system for their return when lost and the payment of a reward to the Finder of the lost article. The basic components of the Asset Registry and Recovery system 20 are depicted in FIG. 1. These basic components include databases 21 that, as will be discussed in detail below, contain information on registered property, unique identifying identification indicia, information on the owner of the property as well as other pertinent information. The system has an administrative unit 23 that operates the system and controls it's functioning. The administrative unit 23 would be operated by among others, by employees, executive personal and technology people who would maintain the computers, communication and other hard ware and software systems of the overall system. As will be discussed below these people will be operating the Asset Registry and Recovery system 20 (the System) personal property. This information would include contact and other personal information on the Finder as well as a list of all those items the Finder has found and returned, and the rewards paid. One of the purposes of sub-database is to protect against the possibility someone might steal personal property registered with System and then return it for the reward offered for its safe return. Thus, the system would keep a record which could be use to find a pattern of suspicious activity by any purported finders.

Finders, Owners as well as the public in general will be able to contact the System through a toll free telephone connection 25 (FIG. 1). Naturally, the system could and would also most likely use non-toll free numbers. However, in the preferred embodiment toll free numbers are used to make it easier for Owners and Finders to contact the System at any time and place when necessary. When the System is contacted by telephone the person will either reach an automated system or an individual. If it is an automated system they wilt be given a series of prompts to provide information. For example an Owner of property registered might contact the system and check on the status of lost property by putting in the unique identifying indicia for the lost property and the System can leave a prerecorded status message that is periodically updated. The Owner might contact the system in order to report that an asset has been lost. This may be done by first entering the unique identifying indicia followed by a secret code number provided to the Owner at the time of initial registration with the system. The Owner would then be given the option to indicate that the asset has been lost, by selecting such an option from a touch-tone menu. The owner could thereby report an asset lost very quickly, whilst following up with more details later when they have access to the Internet. The Owner might contact the system in order to increase or decrease the amount of the reward. This may be done by first entering the unique identifying indicia followed by a secret code according to the rules or concepts set forth herein.

Communication, in most cases, with the system would be through a toll free telephone connection 25 or via an Internet website 27. In most cases Owners 29 of personal property will be communicating with the System regarding the registration of personal property, changes in registration and lost property. Additionally, Finders 31 will also be communicating with the System over the Internet through the Internet website 27 or by telephone 25. Finally, personal property 33 registered with the System will have a tag 35 attached to it that will have unique identifying indicia as well as instructions on how to contact the System 20 if the property is found and that a reward is available to the finder.

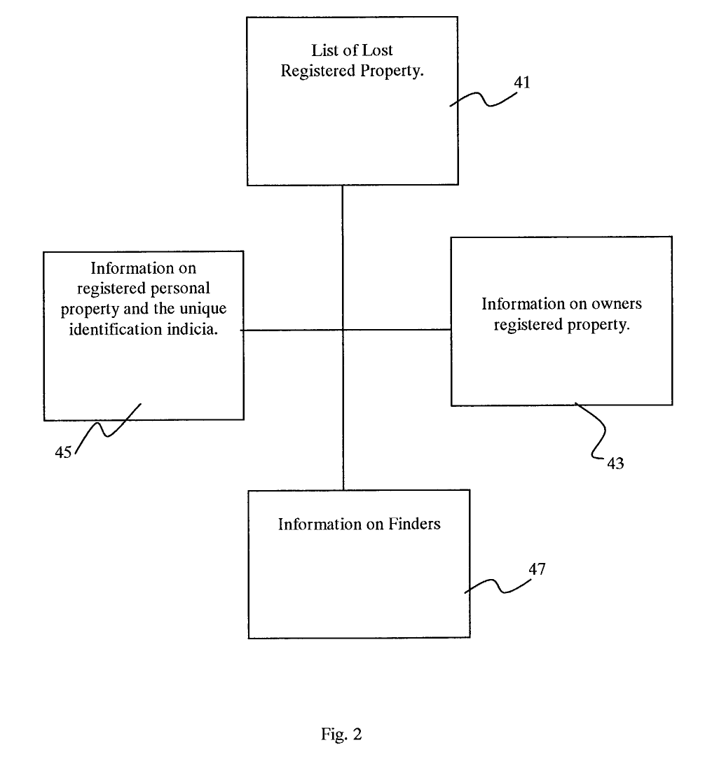

Databases 21 will in a sense be several databases with interrelated information. It will consist of a sub-database 41 (FIG. 2) of the personal property registered with the is System. The registered personal property will have a unique identifying indicia linked to it. It will also have a sub-database 43 of information regarding owners of registered personal property. This information will be crossed indexed with the personal property listed in sub-database 41 as to owner, etc. Once an item of personal property is lost it will be listed as lost in sub-database 45. Sub-database 45 naturally would describe the property lost, perhaps include information on the location the property was lost as well as the time of loss. A picture of the property might also be included for viewing by those who connect to the site over the Internet.

Additionally, the basic System will have a sub-database 47 of information on Finders. Finders are individuals who find the items of lost personal property and return them to the asset registry for the reward to be given for returning the lost item of number provided to the Owner at the time of initial registration with the system. The Owner would then be given the option to choose to increase or decrease the reward by keying in a new amount using the telephone keypad. Finders might also contact the system to find out the extent of a reward, and instructions on how to obtain the reward. The Finder would be able to enter the unique identifying indicia on an item they have found and then choose an option using the touch-tone telephone indicating that they have found the item with that particular Tag attached, and request information on the amount of the reward, and on instructions on how to obtain the reward.

The automated system would naturally include the option of contacting an employee of the System. In most instances the employee contacted would be at a computer with access to the databases of the System. The employee could enter new information from a new customer, enter changes in information on for an existing owner, etc. Additionally, the employee would make arrangements with a Finder for the return of property to that has been found, for payment of the reward, etc.

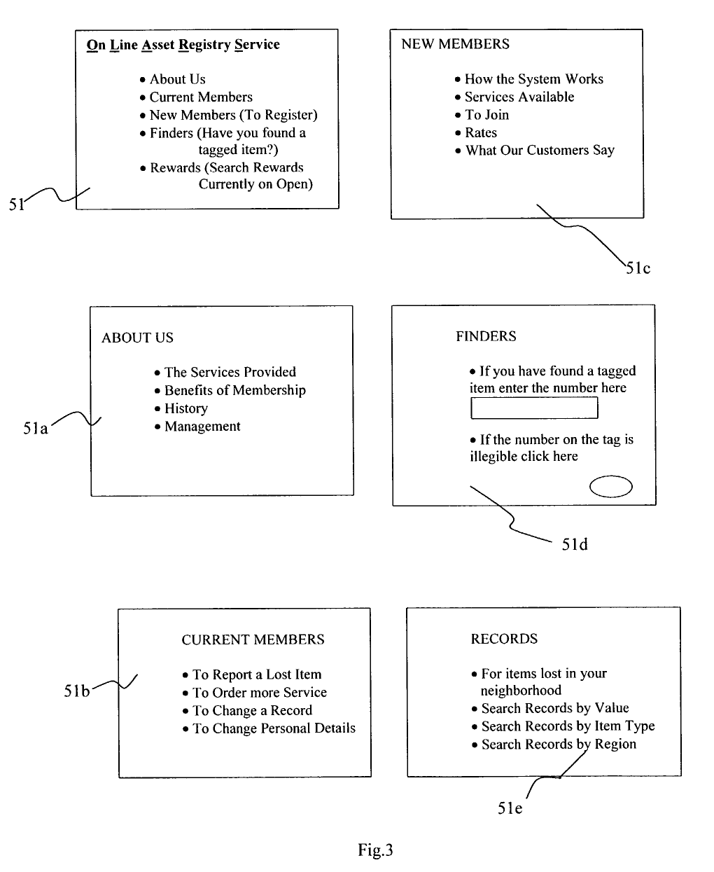

Additionally, the preferred embodiment of the System will be accessible via an Internet website 51 (FIG. 3). The site 51 would provide information on the services offered by the system, their cost, etc. 51A to 51E provide simple examples of additional pages that can be accessed from the main web page 51. Additionally, the System would provide limited access to the sub-databases of the System. Access to the sub-databases would be dependent on the status of the person seeking access. For instance Owners would be given passwords to access certain portions of the information in the databases concerning their property and personal information. This could include the ability to add pictures of the personal property, change the unique identifying indicia from one piece of personal property to another, etc. It may give Owners the ability to change certain of their personal details on the database, such as changes in address, phone numbers, email addresses, etc. It might also include the ability to change the amount of the reward offered for the return of personal property. However, as will be explained below the rewards offered would have a minimum amount below which they cannot be reduced.

Finders will be able to contact the System through the website to access the database of lost personal property, they may be able to check the value of the reward being offered for the item they have found by entering the identifying information on the tag, notify the system that the item has been found and by whom, make arrangements for return of a lost item and receive payment of the reward. The general public will also be able to access the database of lost personal property as well as obtain information on the System and its services. For example the general public may be able to search the database for items reported lost in specific locales, and find details of rewards being offered for such items.

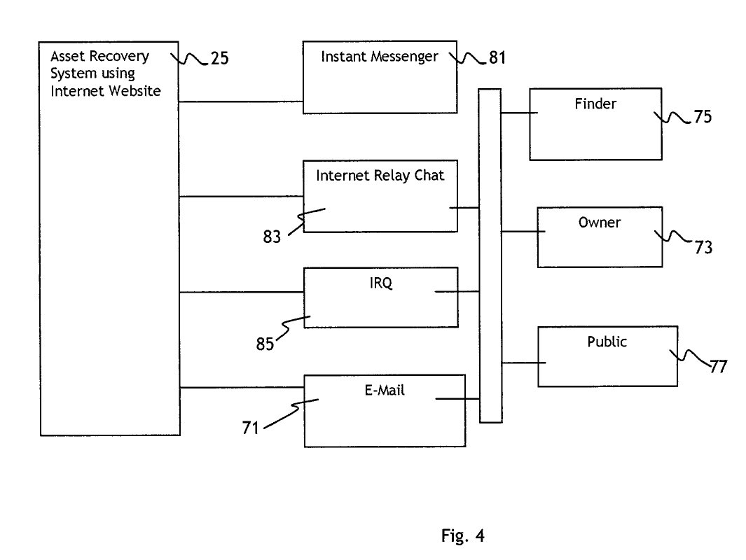

Actual communication with the System by Finders and Owners to “talk” to an employee of the System rather than just view the website 25 can be conducted in a variety of forms. Naturally, use of standard e-mail 71 (FIG. 4) by Owners 73, Finders 75 and the Public 77 would be available. However, a variety of other real time or near real time systems could be used, such as instant messenger 81, internet relay chat 83 and IRQ 85. These systems, their implementation and functioning are well known to those of ordinary skill in the art. In any event such a direct connection would facilitate communication by Owners and Finders with the system.

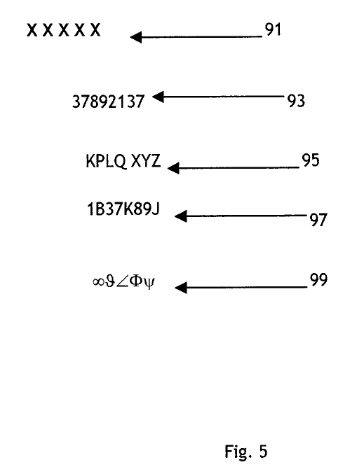

One of the key aspects of the present invention, as noted above, is that each piece of personal property registered with the system will have its own unique identifying indicia 91 (FIG. 5). Unique identifying indicia 91 in the preferred embodiment could be a number 93, letters in a specific sequence 95, an alphanumeric combination 97 or some other type of symbols 99. In the preferred embodiment it would be a number 93 or alphanumeric combination 97. The number 93 or alphanumeric combination 95 would naturally have to be of sufficient length to allow for registration of a large number of items of personal property.

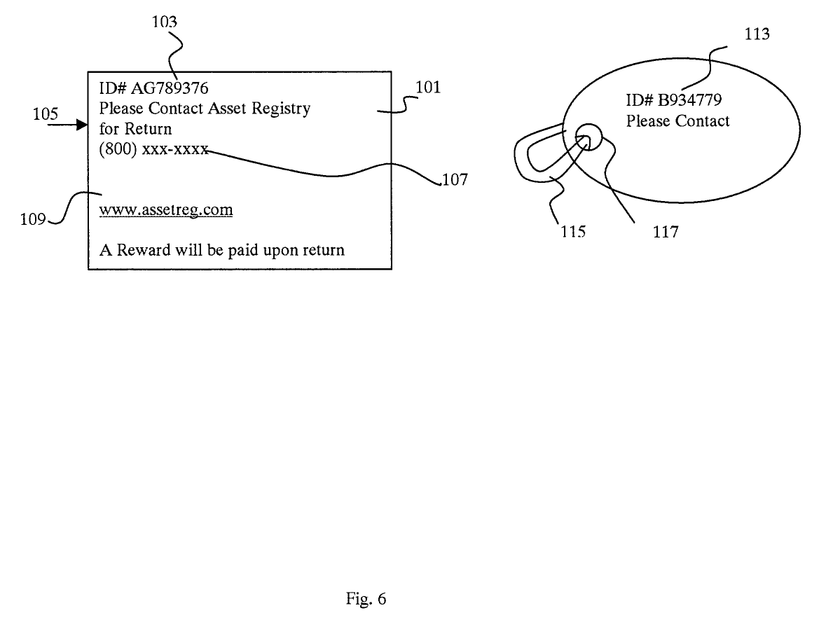

Another key aspect of the invention is the tag 101 (FIG. 6) attached to each item of personal property. Tag 101 will have the unique identifying indicia on it, in the example shown is in the form an alphanumeric combination 103. Tag 101 will also include a request such as “Please contact Asset Registry for return” 105. Tag 101 will also include a telephone number 107, in the preferred embodiment a toll free number and a website 111 to contact. Additionally, in the preferred embodiment Tag 101 will include a statement that “A reward will be paid for return of the property” 111. Thus, when a Finder finds the lost property, upon review of tag 101 the Finder will know whom to contact and how. Additionally, they will be apprised of the fact a reward is offered for the safe return of the item of personal property.

Tag 101 can be attached to the personal property registered in a variety of ways. Tag 101 is on a thin flexible sheet of material, such as plastic, paper or other similar material. Tag 101 would have an adhesive film on its reverse side, not shown, that would allow for its secure attachment to a surface of the item of personal property to be protected. It might be a personal computer, personal digital assistant, other personal electronic device, etc. Naturally, for different items of personal property different means of attaching the tag will be used. Tag 113 might be attached to a key or set of keys. Tag 113 might be made of metal, strong and durable plastic, some type of composite material or any other suitable material. Tag 113 could be attached to the key or set of keys, not shown, by link 115 that connects to Tag 113 through eyelet 117. Tag 113 may be attached in a similar manner to a golfing bag and clubs, a pet collar, luggage and the like. Metal clips of various designs, such as those used in climbing (karabiners), leather or similar straps with holes, and buckles often used as nametags attached to Luggage, etc. can attach the tags to the item of personal property. The identifying information on the Tag may be transferred onto the item by etching, marking, inking, etc if the Tag itself cannot be attached, and the Tag can be held at home. Tags may be made of luxury fabrics to match luxury items like briefcases. Tags may be designed in unique and unusual designs for fun (e.g. heart shapes, or golf ball shapes).

In another aspect of the invention a second tag with the unique identifying indicia can be attached to the item of personal property in an inaccessible position. This would be a means of protecting against theft of the item of personal property. This would allow for its identification if stolen and the visible tag has been removed.

Owners of personal property will be able to register most any item of personal property with the System of the present invention. These can be keys, portable computers, electronic devices, pets, books etc. Additionally, Owners in a preferred version of the invention will be able to set the amount of the reward to be paid upon the finding and return of the personal property. The System will in a preferred embodiment set minimum amounts for the rewards based on the value of the personal property. For instance, for a personal computer the minimum reward might be $100; however, the Owner might set the reward at $500 because of the quality of the computer or simply because it has important information on it. But, if the Owner later decides that the reward is too much he or she can contact the System via any of the means described above and reduce the reward or increase it. However, the Owner will not be able to decrease the reward below $100. The reason for this is to create in the mind of the public and potential Finders the assurance that they will always receive a reward for returning a lost item. The exception to always paying a reward might be in those situations where the owner has advised the System that if the item is damaged significantly he or she dos not want it and to return the damage property to the Finder. In such situations no reward would be paid and the Finder would become the new owner by default.

Additionally, in another variation of the invention an Owner can include the requirement that an item of personal property registered with the System only be returned if it is not damaged or not substantially damaged. Thus, the System when such a requirement exists, will inspect the item of personal property upon its return and if it is damaged more than the Owner finds acceptable, and the Owner does not want it the item of personal property will be returned to the Finder and no reward will be paid.

In a preferred embedment of the invention the Owner registering personal property with the System will enter into a contract with the System whereby the Owner will pay a small yearly subscription fee for registering with the System various items of personal property. The fees would be based on the number of items of personal property registered with the System. Additionally, when an item of personal property registered with the System is lost and then found and returned through the System the Owner will pay a return fee. This fee might be a percentage of the reward paid to the Finder. Naturally, the Owner will also be responsible for paying the reward.

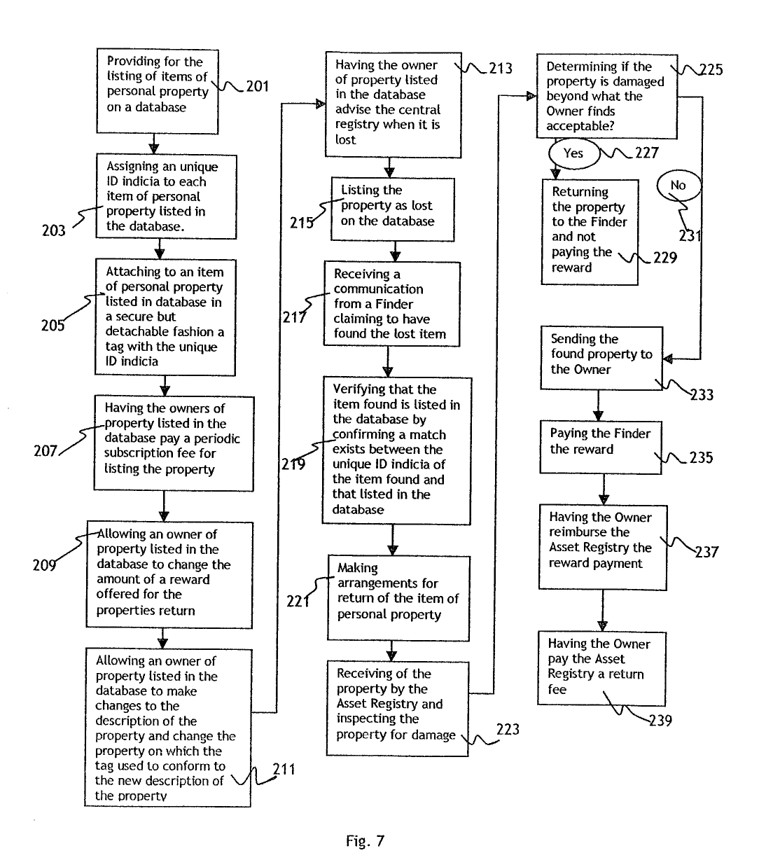

FIG. 7 is flow chart of one preferred mode of operation of the system. Initially, an Owner will register 201 one or more items of personal property in the database of the System. The System will assign 203 unique identification indicia to each item of registered property. Additionally, a tag with the unique identification indicia will be sent to the Owner and attached 205 to each piece of registered personal property. Naturally, the tag with the unique identification indicia that correctly identifies a piece of personal property will be attached to it. The Owners of personal property listed in the database will pay 207 a periodic subscription fee for the service. In most instances this fee would be paid on a yearly basis. The invention in both its system forms, and method forms, could be used by Internet service providers, Insurance companies or similar type of organizations. The System of the present invention could be offered as a free giveaway service, as part of a bundle of several services, or as an add on service. Naturally, the Internet service provider, Insurance company, etc. could charge fees if they so chose.

While an Owner's personal property is listed on the Database the Owner will be is able to change 209 the amount of the reward. However, as noted above they will not be able to reduce it below a preset amount. Also, the Owners will be allowed to change 211 selected personal information, the description of the property or move the tag to different personal property. This might occur if the Owner sells or other wise disposes of personal property.

If personal property listed with the System is lost the Owner would notify 213 the System of the loss of the property. The property lost would them be listed 215 in a lost property sub-database. When a Finder finds what appears to be registered property they will contact 217 the System and so advise the System. The System would then verify that the Finder has indeed found lost property listed with the system by matching 219 the unique identification indicia given by the Finder with the unique identification indicia of property registered with the system. The System would then make arrangements for return 221 of the property to the System. Once the property is received by the System it will inspect 223 it for damage. If the System determines the property damaged beyond 225 what the Owner finds acceptable 227 it will return 229 the property to the Finder and not pay the reward. On the other hand if the System finds the property is not damaged 225 beyond what the Owner would find acceptable 231 it will send 233 it to the Owner. The System will then pay 235 the reward to the Finder. The Owner will be responsible for reimbursing the System for payment 237 of the reward. Additionally, the Owner will have to pay the System a return fee 239 which might be a percentage of the reward or some other agreed to sum. Often there may be situations where a Finder finds tagged lost personal property registered with the System which the Owner has not yet realized is lost, or has not had time to notify the registry of its loss. The System would certainly not have any problems in handling such situations. The Finder upon contacting the System would still be able to find out what the amount of the reward is. The System would upon is being contacted by the Finder determine the Owner has not yet notified the System of the loss. The System would then notify the Owner of the apparent loss and make the usual arrangements for its return.

While the invention has been particularly shown and described with reference to a preferred embodiment thereof, it wilt be understood by those skilled in the art that various changes in form and detail may be made to it without departing from the spirit and scope of the invention.

I claim:

1. A system for identifying items of personal property and providing for their safe and expeditious return to the owner of the personal property, the system comprising:
a central asset registry having a database of items of personal property of various individuals each of said items of personal property is identified by a unique identifying indicia, said unique identifying indicia of each item of personal property being linked to a specific owner;
a tag attached to each item of personal property registered with said asset registry, said tag having said unique identifying indicia emblazoned thereon that corresponds to said unique identifying indicia associated with said item of personal property in said database of said asset registry, said tag also having contact information for said asset registry and a promise of a reward to an individual who notifies said asset registry and turns in the lost item to said asset registry;
said asset registry and said associated database being generally accessible over a public communication network;
wherein upon losing a registered item of personal property, an owner of said lost item of registered personal property can notify said asset registry system to list on said database in a searchable format said item of registered personal property searchable by one or more of the following indicia: owner, unique identifying indicia, description of the property lost and location the item was lost; and
wherein said owner has an option of modifying within certain preset parameters a reward to be offered for return of the lost registered item of personal property and the condition in which the lost item must be returned in order to receive all or part of said reward.

2. The system of claim 1 wherein said method of communicating by a public communication system comprises providing an Internet website accessible over the Internet.

3. The system of claim 1 wherein said method of communicating by a public communication system comprises providing a toll free number to call the asset registry system.

4. The system of claim 1 wherein said asset registry guarantees the payment of said reward.

5. The system of claim 1 wherein the size of said reward is based on the value of the lost article.

6. The system of claim 1 wherein said asset registry maintains a searchable database of finders of lost property that have returned said last property to said asset registry.

7. The system of claim 1 wherein an owner of personal property registered with said asset registry pays a periodic service fee to maintain registry of said personal property with said asset registry. See AOL points.

8. The system of claim 1 wherein an owner of a lost piece of personal property that has been recovered through said asset registry will pay said asset registry a recovery fee.

9. The system of claim 1 wherein said indicia on said tag can be selected from the following group of symbols: numeric, alphabetical, alphanumeric and symbolic.

10. The system of claim 1 wherein an owner of an item of personal property registered with said asset registry can access said database to make changes to a listing of personal property registered with said asset registry.

11. The system of claim 10 wherein said owner can also change the amount of the reward for return of the lost item.

12. The system of claim 11 wherein said owner cannot reduce the amount of the reward below a preset minimum amount.

13. The system of claim 1 wherein anyone with access to said form of public communication system can contact said asset registry system and obtain information on lost property.

14. The system of claim 1 wherein said tag attachable to said items of personal property are selected from the following group: a metal tag attached by a link, a tag on a flexible sheet attachable by an adhesive material and a tag etched on a surface of said item of personal property.

15. The system of claim 1 wherein an owner of said lost item of personal property remains anonymous to a finder.

16. The system of claim 1 wherein a finder has no way of determining who is said owner of said lost item of property through said asset registry.

17. The system of claim 1 wherein an owner of a first item of personal property listed in said database of said asset registry can move a tag on said first item of personal property to a second item of personal property and also update records of said database with information of said second item of personal property.

18. The system of claim 17 wherein said owner can change the value of a reward for finding and returning said second item of personal property.

19. The system of claim 2 wherein an owner of said lost item of personal property will be able to post a picture of the lost item of personal property.

20. The system of claim 1 wherein said asset registry will inspect said item of lost personal property returned by a finder for damage and if it is damaged beyond what an owner of said personal property finds acceptable will return said item of lost personal property to said finder and not pay said reward.

21. The system of claim 1 wherein at least one key can be registered and a flat non-changeable reward amount can be set.

22. The system of claim 23 wherein a set of keys can be registered with said asset registry.

23. The system of claim 2 wherein a finder of an item of lost personal property registered with said asset registry can contact said asset registry by the internet and establish a communicative connection.

24. The system of claim 23 wherein said finder can relay information regarding the condition of said lost item of personal property said finder has found over said communicative connection.

25. The system of claim 23 wherein said finder can make arrangements for return of said lost item over said communicative connection.

26. The system of claim 23 wherein said communicative connection is selected from the following group: an e-mail system, an instant messenger system, an internet relay chat system and a ICQ system.

27. The system of claim 1 wherein a second identification indicia is placed on said item of personal property on a hidden surface to identify said item if stolen.

28. The system of claim 1 wherein said database comprises a structure of interrelated sub-databases including a sub-database of registered property and identifying indicia, a sub-database of information on owners of property with related personal information, a sub-database with information on items of registered personal property that is lost and a sub-database of information on finders of property registered with the database.

29. A system for the recovery of lost property, said system comprising:
a central asset registry with a database listing a plurality of items of personal property, each item of personal property having a unique identifying indicia associated with it;
a tag attached to each item of personal property listed in said asset registry with said associated identifying indicia listed on said tag, wherein said tag has additional information on it on how to contact said asset registry and indications that a guaranteed reward will be given to a finder who finds the item of personal property and returning it to said asset registry; and
wherein said information on how to contact said asset registry uses a public communication system.

30. The system of claim 29 wherein said method of communicating by a public communication system comprises providing an Internet website accessible over the Internet.

31. The system of claim 29 wherein said method of communicating by a public communication system comprises providing a toll free number to call the asset registry system.

32. The system of claim 29 wherein said asset registry guarantees the payment of a minimum preset reward.

33. The system of claim 29 wherein the size of said reward is based on the value of the lost article.

34. The system of claim 29 wherein said system maintains a searchable database of finders of lost property that have returned said last property to said asset registry.

35. The system of claim 29 wherein an owner of personal property registered with said asset registry pays a periodic service fee to maintain registry of said personal property with said asset registry.

36. The system of claim 29 wherein an owner of a lost piece of personal property that has been recovered through said asset registry will pay said asset registry a recovery fee.

37. The system of claim 29 wherein said indicia on said tag can be selected from the following group of symbols: numeric, alphabetical, alphanumeric and symbolic.

38. The system of claim 29 wherein an owner of an item of personal property registered with said asset registry can access said database to make changes to a listing of personal property registered with said asset registry.

39. The system of claim 38 wherein said owner can also change the amount of the reward for return of the lost item.

40. The system of claim 39 wherein said owner cannot reduce the amount of the s reward below a preset minimum amount.

41. The system of claim 29 wherein said owner can access said database and submit information on a lost item of personal property, said property being registered with said asset registry system.

42. The system of claim 41 wherein said information submitted regarding said lost item of personal property is a location where and time that said lost piece of personal property was lost.

43. The system of claim 29 wherein anyone with access to said form of public communication system can contact said asset registry system and obtain information on lost property.

44. The system of claim 29 wherein said tag attachable to said items of personal property are selected from the following group: a metal tag attached by a link, a tag on a flexible sheet attachable by an adhesive material and a tag etched on a surface of said item of personal property.

45. The system of claim 29 wherein an owner of said lost item of personal property remains anonymous to a finder.

46. The system of claim 29 wherein a finder has no way of determining who is said owner of said lost item of property through said asset registry.

47. The system of claim 29 wherein an owner of a first item of personal property listed in said database of said asset registry can move a tag on said first item of personal property to a second item of personal property and also update records of said database with information of said second item of personal property.

48. The system of claim 47 wherein said owner can change the value of a reward for finding and returning said second item of personal property.

49. The system of claim 30 wherein an owner of said lost item of personal property will be able to post a picture of the lost item of personal property.

50. The system of claim 29 wherein said asset registry will inspect said item of lost personal property returned by finder for damage and if it is damaged beyond what an owner of said personal property finds acceptable will return said item of lost personal property to said finder and not pay said reward.

51. The system of claim 29 wherein at least one key can be registered and a flat non-changeable reward amount can be set.

52. The system of claim 52 wherein a set of keys can be registered with said asset registry.

53. The system of claim 30 wherein said finder of an item of lost personal property registered with said asset registry can contact said asset registry by the internet and establish a communicative connection.

54. The system of claim 53 wherein said finder can relay information regarding the condition of said lost item of personal property said finder has found over said communicative connection.

55. The system of claim 53 wherein said finder can make arrangements for return of said lost item over said communicative connection.

56. The system of claim 53 wherein said communicative connection is selected from the following group: an e-mail system, an instant messenger system, an internet relay chat system and a ICQ system.

57. The system of claim 29 wherein a second identification indicia is placed on said item of personal property on a hidden surface to identify said item if stolen.

58. The system of claim 29 wherein said database comprises a structure of interrelated sub-databases including a sub-database of registered property and identifying indicia, a sub-database of information on owners of property with related personal information, a sub-database with information on items of registered personal property that is lost and a sub-database of information on finders of property registered with the database.

59. A method for assuring the return of lost items of personal property, said method comprising the steps of:
a) providing for the listing of items of personal property on a searchable database;
b) assigning a unique identification indicia to each of said items of personal property, which unique identification indicia can be used to quickly identify said personal property to which said unique identifying indicia is assigned;
c) attaching in a secure but detachable fashion a tag to said item of personal property, said tag having said unique identification indicia thereon as well as information on how to contact a central registry if one finds said item of personal property with said tag attached and offering an reward to anyone who finds and returns said item of personal property to said central registry;
d) having an owner of said personal property contact said central registry and list said item of personal property as lost in the event that said item of personal property is lost;
e) posting at an internet website of said central asset registry the fact said item of personal property has been lost;
f) receiving a communication from a finder claiming to have found said lost item of personal property;
g) verifying with said database that said item of personal property found by said finder is the listed on said database by confirming a match between said unique identification indicia on said tag and said unique identification indicia of said item of personal property listed in said database;
h) making arrangements with said finder of said item of personal property to said asset registry;
i) receiving by said central registry said item of personal property found;
j) returning said item of personal property to said owner; and
k) paying a preset reward to said finder.

60. The method of claim 59 including the further steps of:
a) after receiving return of said item of personal property in step i inspecting said item of personal property for damages;
b) having the central registry determine if any damage has occurred to the item of returned personal property;
c) determining if the owner of said personal property will accept return of said personal property with any damage discovered;
d) returning said personal property to said finder if it is determined said owner will not accept said personal property is its inspected state and not paying said reward or sending said personal property to said owner and paying said reward to said finder if said personal property will be accepted by said owner in its inspected state and sending the reward to said finder.

61. The method of claim 59 including the further steps of:
a) having said owner of said property listed with said central registry pay a periodic subscription fee for registering said property with said central registry; and
b) having said owner of said property listed with said central registry pay a return fee upon the return through said registry of said personal property if it has been lost.

62. The method of claim 59 including the further step of allowing said owner of said personal property registered with said registry to change the amount of a reward offered to a finder for sending said personal property to said central registry, wherein said amount said owner can reduce it to can not be reduced below a preset amount.
